(19) United States
(12) Patent Application Publication
(10) Pub. No.: US 2021/0147184 A1
(43) Pub. Date: May 20, 2021

(54) SAFETY DEVICE FOR AN ELEVATOR SYSTEM OR ESCALATOR SYSTEM, ELEVATOR SYSTEM, AND METHOD FOR INDICATING THE STATUS OF A SAFETY CIRCUIT

(71) Applicant: Inventio AG, Hergiswil (CH)

(72) Inventor: Bharat Shah, Ringoes, NJ (US)

(21) Appl. No.: 16/624,337

(22) PCT Filed: Jun. 26, 2018
(86) PCT No.: PCT/EP2018/067009

§ 371 Date: Dec. 19, 2019

(30) Foreign Application Priority Data
Jul. 14, 2017 (EP) 17181513.7

(51) Int. Cl. B66B 5/02; B66B 29/00; B66B 3/00; B66B 27/00

(52) U.S. Cl. CPC B66B 5/02; B66B 27/00; B66B 3/002; B66B 29/00

(57) ABSTRACT

A safety device for an elevator system or an escalator system includes a safety circuit having a plurality of safety circuit elements, wherein the safety circuit is adapted for stopping an operation of the elevator system or escalator system when at least one of the safety circuit elements of the safety circuit opens, a manual service switch for opening at least one of the safety circuit elements of the safety circuit, and a light device adapted to be illuminated in a first illumination color while all the safety circuit elements are closed and to be no longer illuminated in the first illumination color when at least one of the safety circuit elements of the safety circuit is open.

### FIELD

The present invention relates to a safety device for an elevator system or escalator system, an elevator system, and a method for indicating the status of a safety circuit.

### BACKGROUND

Safety devices for an elevator system usually comprise a safety circuit. The safety circuit comprises several safety circuit elements which are wired in series. When one of the safety circuit elements (also called safety switches) opens, the operation of the elevator car/elevator system or escalator/escalator system is stopped.

Typically, at least one manual service switch for opening one of the safety circuit elements and, thus, for stopping the operation of the elevator or escalator system is installed. E.g., an elevator car stop switch, also called run/stop switch, opens one of the safety circuit elements and, thus, stops the operation of the elevator car or elevator system.

One disadvantage of the safety devices for elevator systems or escalator systems known so far is that if the safety circuit element does not open when the corresponding manual switch is used or operated (i.e., the manual service switch is in the off-position), the operation of the system is not stopped even though the person which used or operated the manual service switch, e.g., a maintenance technician, assumes that the operation of the elevator or escalator system has been stopped, i.e., no further movement of the elevator (or escalator) is possible, at least as soon as the elevator has reached a floor or level.

This can lead to dangerous and possibly deadly situations since the person who used the switch assumes a stop of the operation of the system (since the manual service switch is in the off-position), even though the operation of the system has not been stopped. For example, under unfavorable circumstances, it is possible that one of the safety circuit switches will not open, even though the manual service switch has been used or operated (i.e., turned into the off position), due to mechanical problems (dirt etc.) and/or electrical problems (a short-circuit etc.).

There may be a need for a safety device for an elevator system or an escalator system which has an increased safety concerning the switching off of the operation of the system. Also, there may be the need for a method for indicating the status of a safety circuit of a safety device of an elevator system or an escalator system which increases the safety concerning the switching off of the operation of the system.

### SUMMARY

According to a first aspect of the present invention, a safety device for an elevator system or an escalator system is proposed, wherein the safety device comprises—a safety circuit comprising a plurality of safety circuit elements, wherein the safety circuit is adapted for stopping an operation of the elevator system or escalator system when at least one safety circuit element of the safety circuit opens, —a manual service switch for opening at least one of the safety circuit elements of the safety circuit, and —a light device which is adapted to be illuminated in a first illumination color while all safety circuit elements are closed and which is adapted to be no longer illuminated in the first illumination color when at least one safety circuit element of the safety circuit is open.

One advantage hereof is that the status of the safety circuit can be determined technically easily. A further advantage is that the safety device gives feedback if the stopping, i.e., switching off, of the operation of the elevator or escalator system via the manual service switch has been successful. It can be determined easily if the operation of the elevator or escalator system has been stopped when the mechanical service switch has been used or turned into an off-position. This increases the safety. The light device can be disposed close to the manual service switch.

According to a second aspect, an elevator system comprising—an elevator car and —a safety device as described above is proposed.

According to a third aspect, a method for indicating the status of a safety circuit of a safety device of an elevator system or an escalator system via a light device is proposed, wherein the safety circuit comprises a plurality of safety circuit elements which are connected in series and wherein the safety device further comprises a manual service switch for opening at least one of the safety circuit elements of the safety circuit, wherein the method comprises the steps: —illuminating the light device in a first illumination color when all safety circuit elements of the safety circuit are closed, and —changing the illumination color of the light device from the first illumination color when at least one safety circuit element of the safety circuit opens via the manual service switch.

One advantage of this method is that the status of the safety circuit can be determined technically easily. A further advantage is that the method gives feedback if the stopping, i.e., switching off, of the operation of the elevator or escalator system via the manual service switch has been successful. It can be determined easily if the operation of the elevator or escalator system has been stopped when the mechanical service switch has been used or turned into an off-position. This increases the safety. The light device can be disposed close to the manual service switch.

Ideas underlying embodiments of the present invention may be interpreted as being based, inter alia, on the following observations and recognitions.

According to an embodiment, the safety device is adapted such that the illumination of the light device is turned off, when at least one safety circuit element of the safety circuit opens. One advantage hereof is that the light device can be technically simple and can have low production costs.

According to an embodiment, the safety device is adapted such that the illumination of the light device changes from the first illumination color to a second illumination color when at least one safety circuit element of the safety circuit opens, wherein the first illumination color is different from the second illumination color. By this, the safety is further increased, since a power blackout which could also lead to a turning off of the illumination can be distinguished technically easily from an opening of one of the safety circuit elements via the manual service switch. The first illumination color could be green indicating a normal operation. The second illumination color could be red indicating a stop of the operation of the system.

According to an embodiment, the safety device is adapted such that the manual service switch is illuminated by the light device when the light device is illuminated. This increases the logical connection between the light device and the manual service switch. Thus, misunderstandings what the illumination or non-illumination of the light device means are reduced. This increases the safety further.

According to an embodiment, the manual service switch has an at least partially translucent housing and wherein the light device is disposed within the manual service switch. By this, the safety device is technically simple. Furthermore, the light device can have a low luminosity, since all light exiting the manual service switch can reach an observer. No light emitted by the light device has to be reflected to be observable by an observer.

According to an embodiment, the manual service switch is a run/stop-switch, in particular a run/stop switch inside an elevator car of the elevator system. By this, the safety when stopping the movement of the elevator car is increased. Furthermore, the operation of the elevator or escalator can be turned off or stopped without accessing restricted areas of the system.

According to an embodiment, the illumination of the light device changes from the first illumination color to a second illumination color when at least one safety circuit element of the safety circuit opens, wherein the first illumination color is different from the second illumination color. By this, the safety is further increased, since a power blackout which could also lead to a turning off of the illumination can be distinguished technically easily from an opening of one of the safety circuit elements via the manual service switch. The first illumination color could be green indicating a normal operation. The second illumination color could be red indicating a stop of the operation of the system.

The safety circuit is also called safety chain.

It shall be noted that possible features and advantages of embodiments of the invention are described herein partly with respect to a monitoring device, partly with respect to an elevator arrangement comprising such monitoring device and partly with respect to a method for installing such monitoring device. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawing. However, neither the drawing nor the description shall be interpreted as limiting the invention.

### DESCRIPTION OF THE DRAWINGS

FIG. 1 shows a schematic view of an embodiment of a safety device according to the present invention.

The figure is only schematic and not to scale. Same reference signs refer to same or similar features.

### DETAILED DESCRIPTION

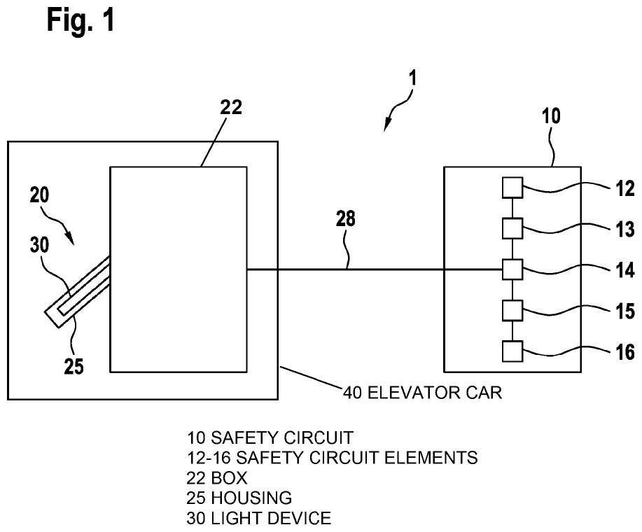

FIG. 1 shows a schematic view of an embodiment of a safety device 1 according to the present invention.

The safety device 1 comprises a safety circuit 10, a manual service switch 20 and a light device 30. The safety circuit 10 comprises a plurality of safety circuit elements 12-16 which are connected in series. The safety circuit 10 is adapted to stop the movement and/or operation of a system when one of the safety circuit elements 12-16 opens. When all safety circuit elements 12-16 are closed, the current flows through the safety circuit 10. This is during normal operation of the system.

The system can be an elevator system or an escalator system. The safety circuit 10 stops the movement of an elevator car (or all elevator cars) of the elevator system or of an escalator (or all escalators) when one of the safety circuit elements 12-16 opens and, thus, the current does not flow through the safety circuit 10.

In FIG. 1, five safety circuit elements 12-16 are connected in series. If one of the safety circuit elements 12-16 opens, the safety circuit 10 opens and stops the movement of the elevator car or escalator.

The manual service switch 20 is adapted for opening at least one of the safety circuit elements 12-16. When the current does not flow through the safety device 1, since at least one of the safety circuit elements 12-16 is open or has opened, the operation of the system (e.g., elevator system or escalator system) is stopped. This means that the elevator moves to the next floor or level and all calls are ignored. This also means that the escalator is stopped immediately or within a few seconds.

The manual service switch 20 can be any kind of switch, which can be actuated manually or with tools. The manual service switch 20 can be a simple projection switch as shown in FIG. 1 or a lock which can be turned or actuated with a special key. Other forms are possible.

The manual service switch 20 has at least one position wherein the system is in normal operation mode. In at least one other position, the so-called off-position, one safety circuit element 12-16 of the safety circuit elements 12-16 is open or opened. Hence, the safety circuit 10 stops the movement of the elevator car or escalator. The normal operation mode ceases.

The other safety circuit elements 12-16 can be connected to other safety critical elements of the elevator system or escalator. When one of them fails, the safety device 1 is also triggered, i.e., the current does not flow through the safety circuit 10 and, thus, the movement of the system is stopped.

The manual service switch 20 projects from a box or enclosure 22. The manual service switch 20 is connected to one safety circuit element 12-16 via a connection line 28.

The light device 30 is connected to the safety circuit elements 12-16 in series. Alternatively, the light device 30 can be connected to the safety element in parallel. Relevant is in particular that the current which flows through the light device 30 changes or changes significantly if one or more of the safety circuit elements 12-16 open.

During normal operation, i.e., when all safety circuit elements 12-16 are closed, the light device 30 is illuminated in a first illumination color, e.g., green. This means that the light device 30 emits light with a first illumination color.

When at least one of the safety circuit elements 12-16 is open or is opened, the light device 30 changes from the first illumination color. The light emitted from the light device 30 can change form a first illumination color to a second illumination color. E.g., the light device 30 changes its illumination color from green to red. It is also possible that the light device 30 is not illuminated when at least one of the safety circuit elements 12-16 is open or is opened. This means that the illumination (also called lighting) of the light device 30 turns off when at least one of the safety circuit elements 12-16 is opened.

The light device 30 can comprise a LED, a light bulb, a fluorescent tube, gas discharge lamp, a halogen lamp, a fluorescent lamp, a metal halide lamp, a sulfur lamp, a high pressure sodium light device, a low pressure sodium light device and/or an electrodeless lamp.

The light device 30 can be disposed in immediate vicinity of the manual service switch 20. E.g., the light device 30 can have a distance of ca. 1 cm, 2 cm or less than 5 cm of the manual service switch 20. The light device 30 can have a label, e.g., “status of the safety circuit”, or something similar to this.

The light device 30 illuminates or shines its illumination color onto the manual service switch 20. This means that the light device 30 emits light such that it seems that the manual service switch 20 has the color of the light emitted by the light device 30. In this case, the light device 30 is spaced apart from the manual service switch 20.

Alternatively, as shown in FIG. 1, the light device 30 is disposed within or in the manual service switch 20. The manual service switch 20 has a housing 25 which is at least partially translucent. Thus, the illumination color of the light device 30 emits out of the service switch.

The person or user or maintenance technician actuating or turning the manual service switch 20 assumes that the operation of the system (elevator system or escalator system) is turned off since the safety circuit 10 is opened when the switch is in the off-position. Via the light device 30, the person or user or maintenance technician can detect the status of the safety circuit 10 easily, i.e., if the operation of the system is stopped or not by the safety circuit 10.

The status of the safety circuit 10 is either open or closed. The status of the safety circuit 10 is “open” when at least one of the safety circuit elements 12-16 is open. When all safety circuit elements 12-16 are closed, the status of the safety circuit 10 is “closed”. When the status of the safety circuit 10 is “open”, the safety circuit 10 or safety device 1 stops all (normal) operation of the elevator or escalator system.

The first illumination color can mean that the safety circuit 10 is closed, i.e., all safety circuit elements 12-16 are closed and the system is in normal operation. If the safety circuit 10 is opened, the color changes from the first illumination color to a second illumination color, wherein the first illumination color is different from the second illumination color, or from the first illumination color to non-illumination, i.e., the light of the light device 30 is turned off.

Thus, the person actuating the manual service switch 20 can detect if the safety circuit element 12-16 does not open even though it should have opened. This can be due to mechanical problems, like dirt, or due to electrical problems, like a short-circuit. If the person is turning the manual service switch 20 in the off-position, the safety circuit element 12-16 connected to the manual service switch 20 should open.

If the corresponding safety circuit element 12-16 is opened, the safety circuit 10 is opened and, thus, the illumination or lighting of the light device 30 will change from the first illumination color, i.e., will be altered from the first illumination color.

If the illumination color does not change when the manual service switch 20 is turned to the off-position, it can or has be assumed that the safety circuit 10 did not open. I.e., the operation of the system or the movement of the elevator has not been stopped by the safety circuit 10. This means that no person should enter the elevator shaft (outside of the elevator car) or do similar things, because the elevator still could move due to normal elevator calls.

The same applies mutatis mutandis to an escalator system. Before any maintenance work should be conducted, the problem why the safety circuit 10 did not open even though the manual service switch 20 is in the off-position should be researched and/or identified. Thus, the safety of the system is increased.

The manual service switch 20 can be a run/stop-switch. The manual service switch 20 can be disposed in the elevator car 40, at one or more elevator doors at the different levels, in the pit of the elevator shaft and/or on top of the elevator car.

Also disclosed herein is an escalator system comprising an escalator and a safety device 1 as described above.

When the operation of the system is stopped via the safety circuit 10, the elevator car (or escalator) still can be moved, but not with the normal elevator calls but only with special buttons or commands which require certain privileges (e.g., a maintenance key, special command coders or buttons not normally accessible by the public, like a pit switch or buttons on top of the elevator car).

The plurality of safety circuit elements 12-16 can comprise exactly two, three, four, five, six or more than six safety circuit elements 12-16.

The first illumination color can be green, indicating a normal operation of the elevator or escalator system. The second illumination color can be red, indicating a stopping of the operation of the elevator or escalator system. Other first illumination colors, e.g., blue, yellow or red, are possible. Other second illumination colors, e.g., blue, yellow or green, are possible.

The system gives an immediate optical feedback if the elevator or escalator system is a normal operation mode or if the operation of the elevator or escalator system has been stopped, i.e., if the system is in a so-called maintenance mode. In the maintenance mode, the elevator or escalator still can be moved but not with the normal elevator calls or similar tools but only with special maintenance codes and/or buttons which are usually not publicly accessible. In particular, an optical feedback is given if the switching of the system from the normal operation mode to the stopping/maintenance mode by opening at least one of the safety circuit elements 12-16 has been successful.

This increases the safety since—without such a feedback—one would assume that the operation of the system has been stopped if the manual service switch 20 is put into the off-position, but under unfavorable circumstances the system is still in normal operation mode. I.e., one normally assumes that by using the manual service switch 20 the status of the safety circuit 10 (from closed to opened) has changed, but under unfavorable circumstances, this is not the case.

Finally, it should be noted that the term “comprising” does not exclude other elements or steps and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SIGNS

1 safety device

10 safety circuit

12-16 safety circuit element

20 manual service switch

22 box

25 housing of the manual service switch

28 connection line

30 light device

40 elevator car

1-9. (canceled)

10. A safety device for use with a system being an elevator system or an escalator system, the safety device comprising:
a safety circuit including a plurality of safety circuit elements that are normally closed during an operation of the system, wherein the safety circuit is adapted for stopping the operation of the system when at least one of the safety circuit elements opens;
a manual service switch for opening at least one of the safety circuit elements; and
a light device adapted to be illuminated in a first illumination color while all of the safety circuit elements are closed and is adapted to be no longer illuminated in the first illumination color when at least one of the safety circuit elements is open.

11. The safety device according to claim 10 wherein the light device turns off the illumination in response to the at least one of the safety circuit elements being open.

12. The safety device according to claim 10 wherein the light device changes from the first illumination color to a second illumination color in response to the at least one safety circuit element being open, wherein the first illumination color is different from the second illumination color.

13. The safety device according to claim 10 wherein the manual service switch is illuminated by the light device when the light device is illuminated.

14. The safety device according to claim 13 wherein the manual service switch has an at least partially translucent housing and wherein the light device is disposed within the manual service switch housing.

15. The safety device according to claim 10 wherein the manual service switch is a run/stop-switch.

16. The safety device according to claim 15 wherein the run/stop-switch is adapted for use inside an elevator car of the elevator system.

17. An elevator system comprising:
an elevator car; and
the safety device according to claim 10 disposed in the elevator car.

18. A method for indicating a status of a safety circuit of a safety device for use with a system being an elevator system or an escalator system, wherein the safety circuit includes a plurality of safety circuit elements connected in series and a manual service switch for opening at least one of the safety circuit elements, the method comprising the steps of:
providing a light device;
illuminating the light device in a first illumination color when all of the safety circuit elements are closed; and
changing the illumination color of the light device from the first illumination color when at least one of the safety circuit elements is opened by operation of the manual service switch.

19. The method according to claim 18 including changing the illumination color of the light device from the first illumination color to a second illumination color when the at least one safety circuit element is opened, wherein the first illumination color is different from the second illumination color.
